(19) United States
(12) Patent Application Publication
(10) Pub. No.: US 2019/0102533 A1
(43) Pub. Date: Apr. 4, 2019

(54) Peripheral Cyber-Security Device

(71) Applicant: Stryker Corporation, Kalamazoo, MI (US)

(72) Inventors: Bijoy S N Sagar, Franklin Lakes, NJ (US); Kavita Hopf, Ridgewood, NJ (US); Alex Petrov, Ridgewood, NJ (US); Richard Friedland, Sarasota, FL (US)

(73) Assignee: Stryker Corporation, Kalamazoo, MI (US)

(21) Appl. No.: 16/141,224

(22) Filed: Sep. 25, 2018

Related U.S. Application Data
(60) Provisional application No. 62/703,068, filed on Jul. 25, 2018.
(60) Provisional application No. 62/567,810, filed on Oct. 4, 2017.

(51) Int. Cl. G06F 21/34; G06F 21/82; G06F 21/55; H04L 29/06; H04W 4/029; H04W 12/06

(52) U.S. Cl. CPC G06F 21/34; G06F 21/82; G06F 21/554; H04L 63/0876; H04W 12/06; H04L 63/0428; H04L 63/1441; H04L 63/1416; H04W 4/029; H04L 63/0853

(57) ABSTRACT

A peripheral cyber-security device is provided for a host device, such as but not limited to a medical/surgical device to provide cyber-security features for the host device. The peripheral device and the host device are hardware specific such that the peripheral device is used solely for the specific host device. The devices authenticate using unique device ID handshaking and the peripheral device provides services, such as external firewall capabilities, data encryption, IP masking, tampering/intrusion mitigation (e.g., circuit breaking), and the like. A fleet of peripheral devices, used among a plurality of corresponding host devices, can be managed as part of a remote management service. The remote management service can remotely send updates to and monitor the peripheral devices and host devices.

### CROSS-REFERENCE TO RELATED APPLICATIONS

The subject application claims priority to and the benefits of U.S. Provisional Patent Application No. 62/567,810, filed Oct. 4, 2017 and U.S. Provisional Patent Application No. 62/703,068, filed Jul. 25, 2018, the contents of which are herein incorporated by reference in their entirety.

### BACKGROUND

### 1. Technical Field

The disclosure relates to systems, devices, and techniques for using a locally installed peripheral device that provides cyber-security capabilities for a host device.

### 2. Description of Related Art

Cyber-security is an on-going concern for devices used in sensitive fields, such as the medical field. All medical devices carry a certain amount of information security risk. The FDA allows devices to be marketed when there is a reasonable assurance that the benefits to patients outweigh the risks. While the increased use of wireless technology and software in medical devices improves health care and increases the ability of health care providers to treat patients, such use also increases the risks of potential cyber-security threats.

Addressing cyber-security threats, and thus reducing information security risks, is especially challenging. Because cyber-security threats cannot be completely eliminated, manufacturers, hospitals and facilities must work to manage them. There is a need to balance protecting patient safety and promoting the development of innovative technologies and improved device performance.

The FDA regulates that design of medical devices conform to standards defined by 21 CFR 820.30(i). Medical devices can have various different platforms, some of which may be legacy platforms. Medical devices are often the “weak link” in the chain of security. As such, achieving conformance of medical devices to the regulated standards is a challenging endeavor. Cyber-security devices and techniques for solving at least the aforementioned challenges are desired.

### SUMMARY

This Summary introduces a selection of concepts in a simplified form that are further described below in the Detailed Description below. This Summary is not intended to limit the scope of the claimed subject matter nor identify key features or essential features of the claimed subject matter.

One example of a system is disclosed herein. The system comprises a host device configured to communicate over a network. The host device comprises a first processor, a first memory component coupled to the first processor and configured to store a first unique device identifier (UDID) associated with the host device, and a first interface coupled to the first processor. The system comprises a peripheral device being separate and distinct from the host device and comprising a second processor and a second memory component coupled to the second processor and that is configured to store a second UDID associated with the peripheral device. The peripheral device comprises a second interface coupled to the second processor and with the second interface configured to physically and removably attach to the first interface to trigger evaluation of the UDIDs to establish authentication between the host device and the peripheral device such that the peripheral device is operable solely with the host device. The peripheral device is configured to implement cyber-security features for the host device relative to the network when authenticated.

One example of a peripheral device for implementing cyber-security features for a host device is disclosed herein. The host device is configured to communicate over a network and comprises a first processor, a first memory component coupled to the first processor and configured to store a first unique device identifier (UDID) associated with the host device, and a first interface coupled to the first processor. The peripheral device is separate and distinct from the host device and comprises a second processor, a second memory component coupled to the second processor and configured to store a second UDID associated with the peripheral device, and a second interface coupled to the second processor. The second interface is configured to physically and removably attach to the first interface to trigger evaluation of the UDIDs to establish authentication between the host device and the peripheral device such that the peripheral device is operable solely with the host device. The second processor of the peripheral device is configured to implement cyber-security features for the host device relative to the network when authenticated.

One example of a remote management service is disclosed herein. The remote management service is implemented on a remote server and configured to remotely monitor and manage the peripheral device(s) described herein.

One example of a method of providing cyber-security to the host device is disclosed herein. The method uses the peripheral device described herein.

One example of a computer-implemented method for remotely monitoring a plurality of peripheral devices using a remote service implemented on a remote server is disclosed herein. Each peripheral device is configured to communicate with the remote server over a network and each peripheral device is uniquely paired with a corresponding host device such that each peripheral device is operable solely with the corresponding host device. Each peripheral device comprises an interface configured to physically and removably attach to an interface of the corresponding host device for triggering an authentication process with the corresponding host device. Each peripheral device is configured to implement cyber-security features for the corresponding host device when authenticated. The computer-implemented method comprises communicating with the peripheral devices over the network using the remote server. The remote server remotely monitors cyber-security features or behavior of the peripheral devices. The remote server detects an occurrence relating to cyber-security features or behavior of one or more peripheral devices and executes a computer-implemented action to address the occurrence.

The system, peripheral devices, methods, and techniques described herein, provide numerous benefits. The techniques mitigate cyber-security risks for devices used in sensitive fields, such as the medical field. The techniques achieve conformance of FDA regulations for medical device security while at the same time provide a universal solution for any type of medical device platform (including legacy platforms) by virtue of the peripheral device. Through the peripheral devices, the remote management service consolidates cyber-security management of all host devices to one central point, thereby alleviating burden of device manufacturers, hospitals and facilities to individually manage cyber-security. Furthermore, by being a device separate from the host device, the peripheral device enables an architectural shift of security features to the peripheral device rather than the host device. This enables a security threat to be mitigated by the peripheral device before compromising the host device. Furthermore, having the peripheral device as a separate device provides added benefit of selective connectivity, and remote management of the peripheral device, or many peripheral devices. Further advantages of a separate peripheral device include providing a streamlined cyber-security platform that reduces the need for significant modification of host devices. The system, peripheral devices, methods, and techniques described herein may exhibit advantages other than those described herein.

### BRIEF DESCRIPTION OF THE DRAWINGS

Other aspects, features, and advantages of the present invention will become more fully apparent from the detailed description, the appended claims, and the accompanying drawings wherein like reference numerals identify similar or identical elements.

FIG. 1 is a perspective view of an example surgical robotic system configured with host devices each receiving a peripheral device configured to provide cyber-security capabilities for the respective host device.

FIG. 2 is a block diagram illustrating one example of a secure communication system comprising the host device, the peripheral device, a network, and a remote server including sub-components and sub-features thereof.

FIG. 3 is a perspective view of one example of the peripheral device.

FIG. 4A is a perspective view of the peripheral device and a locking mechanism of the host device.

FIG. 4B is a cross-sectional view of a direct interface of the host device and a direct interface of a peripheral device after the direct interfaces are physically connected.

FIG. 4C is a cross-sectional view of the direct interfaces of the host device and the peripheral device after the direct interfaces are physically connected and after the locking mechanism is actuated.

FIG. 5 is a method sequence diagram illustrating various cyber-security features employed by the peripheral device with respect to the host device and the remote server.

FIG. 6 is another method sequence diagram illustrating cyber-security features employed by the peripheral device with respect to the host device and a foreign/malicious server.

FIG. 7 is a block diagram illustrating techniques for determining a location of the peripheral device.

FIG. 8 is a system diagram of one example of a remote management service configured to update and monitor a fleet of peripheral devices over a network.

### DETAILED DESCRIPTION

Referring to the Figures, wherein like numerals indicate like or corresponding parts throughout several views, aspects of a peripheral device 10 and systems, methods, and techniques related to the same are provided.

### I. Overview

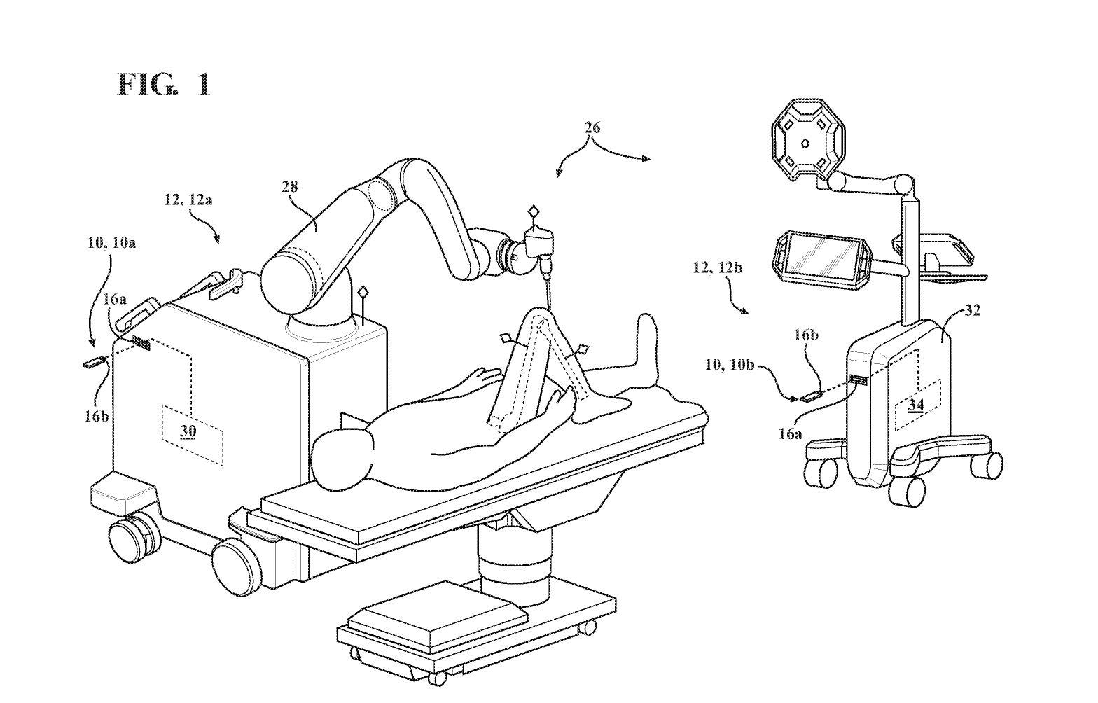

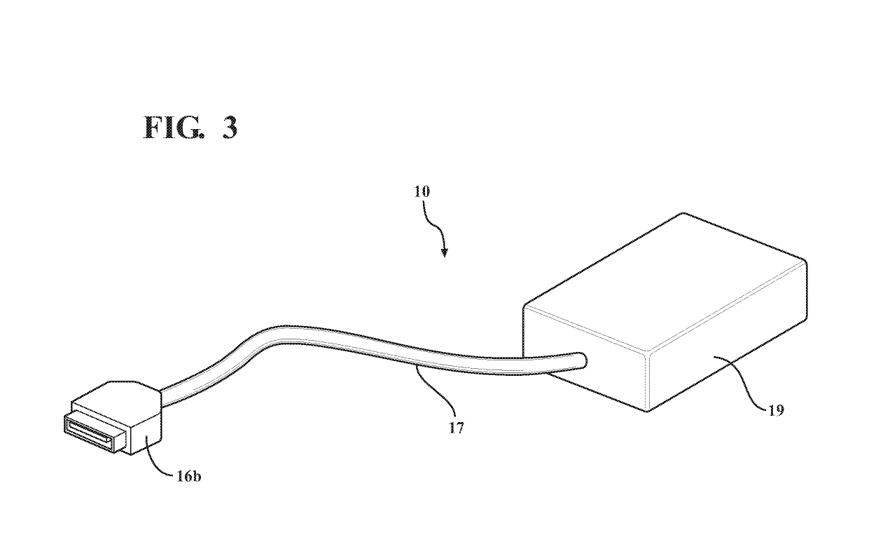

Referring to FIGS. 1-3, the peripheral device 10 is an auxiliary product that can be inserted into, or otherwise selectively coupled to, a host (client or parent) device 12 to provide cyber-security services for the host device 12. In one embodiment, as shown in FIGS. 1 and 3, the peripheral device 10 is a pocket-sized external hardware device that is distinct from the host device 12. Hardware and software architecture of the peripheral device 10 is further described below. Two host devices 12a, 12b are shown in FIG. 1.

The peripheral device 10 is provided on-premises at a location of the host device 12. In other words, the peripheral device 10 is located at the same location as the host device 12, rather than being remotely located, e.g., across a network. As will be understood by the description and examples herein, the peripheral device 10 is provided on-premises relative to the location of the host device 12 because, in part, peripheral device 10 and the host device 12 must be physically connected to each other using direct interfaces 16a, 16b, respectively. The direct interfaces 16a, 16b are hard-tethered or hard-wired thereby avoiding any vulnerable wireless connection between the peripheral device 10 and the host device 12. By avoiding wireless connection between the peripheral device 10 and the host device 12, the techniques described herein maximize cyber-security capabilities of the peripheral device 10 and minimize intrusions that may otherwise occur over such vulnerable wireless connections.

In some examples, as shown in FIG. 3, the peripheral device 10 may include a cable 17 connected between the main hardware sub-components (described below) of the peripheral device 10 and the direct interface 16b. The cable 17 may be of any length and may be provided for convenience of connecting the peripheral device 10 to the host device 12. The peripheral device 10 may include a housing 19 for any of the sub-components of the peripheral device 10. In one example, the cable 17 is coupled between the direct interface 16b and the housing 19. In another example, the direct interface 16a is coupled directly to, or integrated with the housing 19, i.e., without the cable 17, such that the peripheral device 10 has a configuration similar to a stick, dongle, card, etc. The peripheral device 10 may have a physical configuration different from the configuration shown in FIGS. 1 and 3.

The housing 19 of the peripheral device 10 may be tamper resistant and may comprise specialized materials, such features as hardened steel enclosures, locks, encapsulation, security fasteners, etc. Tamper evident features, such as seals, stickers, markers, coatings or indicators, may also be provided on the housing 19 to inform users if the peripheral device 10 has been tampered with. Such tamper-evidence techniques may be in compliance with The Federal Information Processing Standard (FIPS) Publication 140-2, Security Level 2 standard.

In yet another example, the peripheral device 10 is implemented on a printed circuit board (PCB) and/or as a system-on-chip (SOC) separate from the host device 12 and configured for installation into the host device 12. A user interface, indicators, and user controls may be coupled to the host device 12 and/or the peripheral device 10 to enable a user of the host device 12 to manipulate connection between the devices 10, 12 and capabilities of the peripheral device 10. When installed on the PCB or as an SOC, the user interface, indicators, and user controls may be located on the host device 12 itself. Additionally, or alternatively, any of the same may be located on the peripheral device 10.

By being a device separate from the host device 12, the peripheral device 10 enables an architectural shift of security features to the peripheral device 10 rather than the host device 12. This enables a security threat to be mitigated by the peripheral device 10 before compromising the host device 12. Furthermore, as will be appreciated below, having the peripheral device 10 as a separate device provides added benefit of selective connectivity, and remote management of the peripheral device 10, or many peripheral devices 10. Further advantages of a separate peripheral device 10 include providing a streamlined cyber-security platform that reduces the need for significant modification of host devices 12.

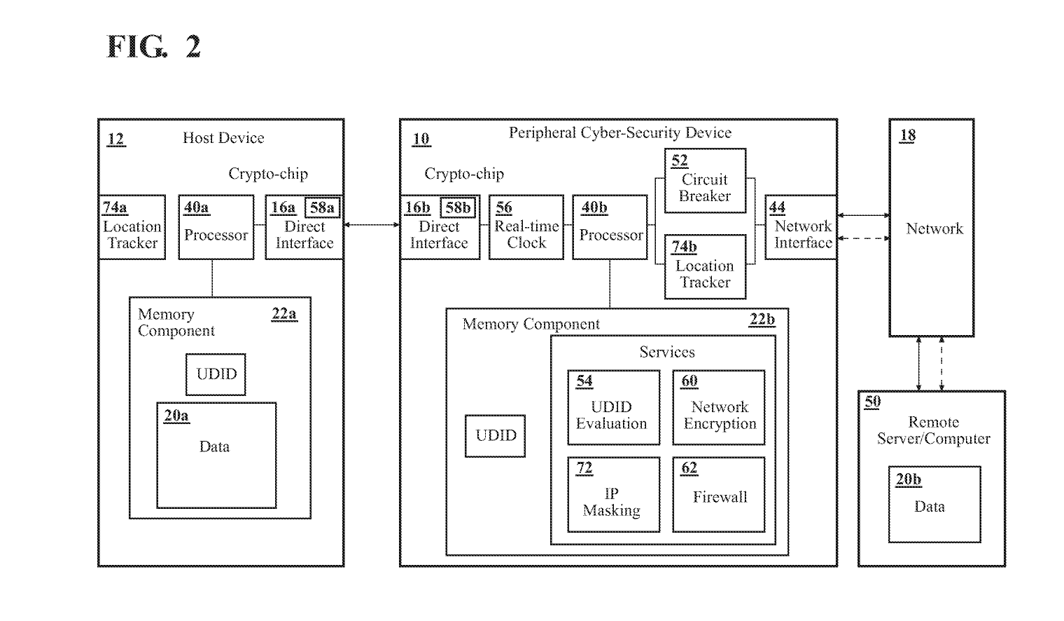

Referring to FIG. 2, the host device 12 is any type of device capable of sending data 20a and/or receiving data 20b over a network 18, such as an open network. The data 20a, 20b is generally sensitive data that demands cyber-security measures to be taken. Protecting the host device 12, and transmission of the sensitive data 20a, 20b over the network 18 are a major focus of the cyber-security services provided by the peripheral device 10.

To further maximize security, a single peripheral device 10 and a single host device 12 are uniquely paired using hardware and/or software to work with each other. In other words, the peripheral device 10 cannot be used or re-used with another host device 12 to provide cyber-security services to such other host devices 12. Furthermore, the single host device 12 is uniquely configured to accept only the single peripheral device 10 which is paired with the single host device 12.

Further hardware and/or software modifications may be made to the host device 12 to provide integration with the peripheral device 10. Such modifications to the host device 12 are further described below.

When the peripheral device 10 is successfully authenticated with the corresponding host device 12, the peripheral device 10 protects the host device 12 using a variety of cyber-security features. Such features include, but are not limited to, network access control for the host device 12, firewall capabilities and intrusion prevention control for the host device 12, circuit-breaking capabilities to cut-off network connection of the host device 12, Internet Protocol (IP) masking to protect the host device 12, data encryption services for data 20a, 20b transmitted to/from the host device 12, connectivity to a remote security management system for monitoring and security updates, and the like.

As shown in one embodiment of FIG. 1, the host device 12 may be configured for surgical applications. For example, as shown, two separate host devices 12a, 12b are provided as part of a surgical robotic system 26. Each separate host device 12a, 12b is uniquely paired with a separate peripheral device 10a, 10b, respectively. It should be appreciated that depending on the host system configuration, and the source of data transmission/reception in the host system, any number of separate host devices 12 and any number separate peripheral devices 10 may be utilized. In FIG. 1, the first host device 12a includes a robotic manipulator 28 comprising a manipulator computer 30. The second host device 12b includes a guidance cart 32 comprising a navigation computer 34.

In this example, the host devices 12a, 12b are configured to transmit and receive sensitive data 20a, 20b over the network 18 for implementing a patient-specific surgical procedure. In some instances, only the guidance cart 32 is configured to transmit and receive data 20a, 20b over the network 18. Such data 20a, 20b may include patient-specific preoperative surgical plans, preoperative or intraoperative patient-specific images (e.g., DICOM), data recorded during intraoperative operation of any components of the surgical robotic system 26, error messages or warnings triggered before, during or after surgery, configuration data, software updates, firmware updates, and the like.

Whether used for medical/surgical applications or otherwise, the peripheral device 10 may be used any time wherein the host device 12 desires or requires connection to the network 18. With medical/surgical applications, for example, the peripheral device 10 may be utilized before, during or after any medical/surgical procedures. Thus, while FIG. 1 illustrates use of the peripheral devices 10a, 10b while a patient is in an operating room during surgery, the peripheral devices 10a, 10b may be utilized additionally, or alternatively, before or after surgery.

One example of a surgical robotic system that transmits/receives data over a network is described in U.S. Patent Application Pub. No. 2017/0239000, entitled “System and Method for Arranging Objects in an Operating Room in Preparation for Surgical Procedures,” filed Mar. 3, 2013, the disclosure of which is hereby incorporated by reference in its entirety.

While FIG. 1 illustrates an example of host devices 12a, 12b for the surgical robotic system 26, the host device 12 may be configured for other surgical and/or medical systems/devices, such as, but not limited to, hand-held surgical robotic systems or tools, radio frequency (RF) generators or consoles, ultrasonic generators or consoles, waste management systems, sponge-monitoring systems, tourniquet systems, endoscopic systems, patient support apparatuses, and any other surgical or medical device that may transmit/receive data 20a, 20b directly or indirectly related to patients.

In other examples, the host device 12 is configured for applications or fields other than medical/surgical, which may demand cyber-security measures to protect sensitive data 20a, 20b transmission over the network 18. For instance, the host device 12 can be configured for any one or more of the following: financial institutions, corporations or businesses (e.g., offices, stores), schools, government services, automotive or aerospace applications, oil/gas applications, industrial/construction applications, personal/consumer use, and the like.

Examples of host devices 12 include, but are not limited to, desktop computers, servers, mobile computing devices (such as laptops, tablets and smart phones), printers, monitors, household appliances, utility meters, machinery, automobile systems, robots, construction equipment, gaming consoles, security/surveillance systems, building management systems, and the like.

While the examples above describe various examples of fields or applications for the host device 12, it should be understood that the corresponding peripheral device 10 for any of these host devices 12 can also be understood to be configured for similar fields or applications. The peripheral device 10 and host device 12 may be utilized in fields or for applications other than those specifically listed herein.

### II. Physical Architecture of Peripheral Device, Host Device and System

Referring to FIG. 2, a system block diagram is provided to illustrate one example of components, features, and connectivity of the peripheral device 10, host device 12 and network 18.

The peripheral device 10 and the host device 12, according to one example, each comprise a processor 40a, 40b, respectively. The processor 40a of the host device 12 is coupled to a memory component 22a of the host device 12. The processor 40b of the peripheral device 10 is coupled to a memory component 22b of the peripheral device 10. The processors 40a, 40b can be a microprocessor, a microcontroller, a field programmable gate array (FPGA), a system on a chip (SOC), or any other suitable type of processor for executing any of the functions described herein.

The memory components 22a, 22b each comprise a non-transitory computer readable medium. The memory components 22a, 22b can include read-only memory (ROM), random access memory (RAM), flash memory, EEPROM, non-volatile random access memory (NOVRAM), or any other suitable form of memory.

Each memory component 22a, 22b is configured to store software instructions that can be executed by the respective processor 40a, 40b. When the processor 40a of the host device 12 executes the instructions, the processor 40a is configured to perform any of the functions or techniques described herein for the host device 12. When the processor 40b of the peripheral 10 executes the instructions, the processor 40b is configured to perform any of the functions or techniques described herein for the peripheral device 10. The processors 40a, 40b may work in conjunction with one another to perform the functionality described. The memory component 22a of the host device 12 may be accessed by the processor 40b of the peripheral device 10, and vice-versa.

The host device 12 and the peripheral device 10 each comprise the direct interfaces 16a, 16b, respectively. The direct interface 16a of the host device 12 is coupled to the processor 40a of the host device 12 and the direct interface 16b of the peripheral device 10 is coupled to the processor 40b of the peripheral device 10.

The direct interfaces 16a, 16b can include any physical and direct connection for providing hard-tethered or hard-wired contact between the host device 12 and the peripheral device 10. As such, the direct interfaces 16a, 16b avoid any wireless connection between the host device 12 and the peripheral device 10 to maximize security.

When connected, the direct interfaces 16a, 16b implement a communication bus or port that enables secure transmission of data 20a, 20b between the host device 12 and the peripheral device 10. As will be described below, transmission of data 20a, 20b across the direct interfaces 16a, 16b is encrypted. In some embodiments, the direct interfaces 16a, 16b also enable a power distribution channel to provide a power supply for the peripheral device 10, or any components thereof. Additionally or alternatively, the peripheral device 10 may comprise a dedicated power supply for powering the components of the peripheral device 10.

The direct interfaces 16a, 16b are configured to communicate using a common protocol. The direct interfaces 16a, 16b can be corresponding (male/female) connectors of any suitable connection method and/or respecting any suitable industry standard, such as, but not limited to the following: on-chip peripheral bus, Universal Serial Bus (USB), IEEE 1394 interface (FireWire), Ethernet, serial AT attachment (eSATA), ExpressCard bus, PCI Express connections, Fibre Channel (FC), Fieldbus, Lightning bus, Thunderbolt, RS-232 bus, RS-485, controller area network (CAN) bus, High Performance Parallel Interface (HIPPI) bus, General Purpose Interface Bus (GIPB), PC Card bus, and the like.

Despite unique pairing of one host device 12 and one peripheral device 10, the direct interfaces 16a, 16b may nevertheless be universal connections that are configured to connect to devices other than the uniquely paired host device 12 or peripheral device 10. Such universal connections may be provided to facilitate easy replacement of inoperable peripheral devices 10, and to enable a peripheral device 10, uniquely paired with one host device 12, to be reconfigured/reassigned for unique pairing with a different host device 12.

In other examples, the direct interfaces 16a, 16b are uniquely designed mechanically/physically to connect to one another. In such instances, the direct interfaces 16a, 16b may include unique physical features such as keying, locking, grooves, pin locations, pin numbers, tabs. Such features may be provided to prevent insertion of unwanted/malicious devices having universal connections into the host device 12. Such techniques may be utilized in addition to unique pairing techniques implemented by software, as described herein.

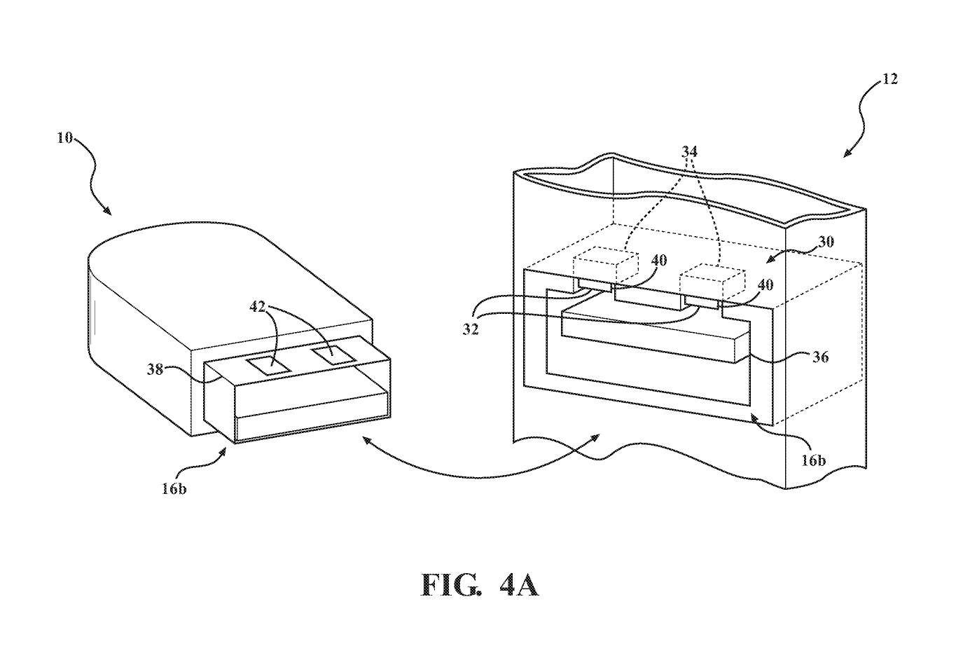

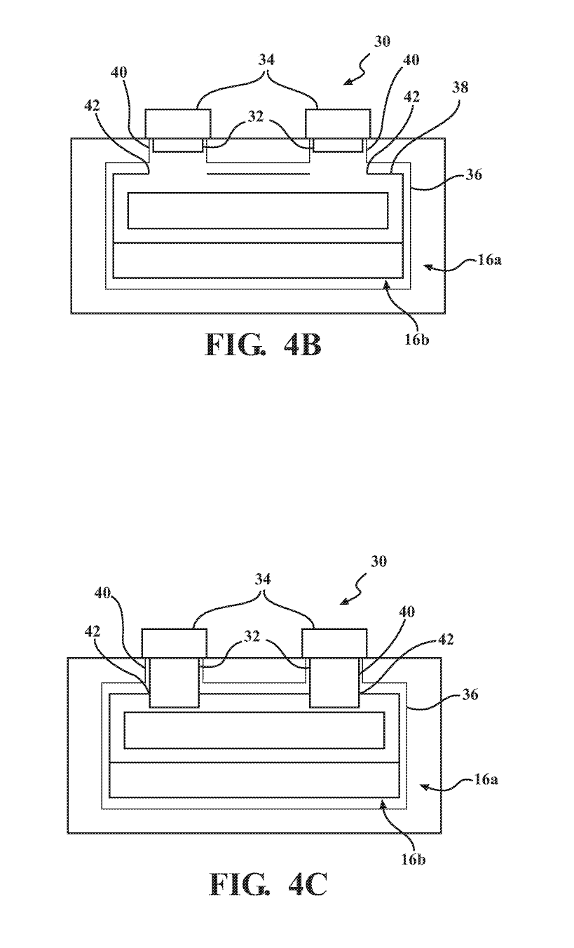

In one such embodiment, the host device 12 may include a locking mechanism 30 as shown in FIGS. 4A-4C. Upon being actuated, the locking mechanism 30 locks the peripheral device 10 to the host device 12 via the direct interfaces 16a, 16b.

In FIG. 4A, perspective views of the peripheral device 10 and the host device 12 are shown. As shown, the host device 12 includes one embodiment of the locking mechanism 30, which is disposed above the direct interface 16a. The locking mechanism 30 includes actuators 34 and actuatable members 32. The host device 12 also includes a housing 36 with openings 40. Also shown, the peripheral device 10 includes the direct interface 16b, which includes a housing 38 with openings 42. As such, after the direct interfaces 16a, 16b are physically connected, the locking mechanism 30 locks the peripheral device 10 to the host device 12 by actuating the actuatable members 32 through the openings 40, 42 of the host device 12 and the peripheral device 10.

FIG. 4B illustrates a cross-sectional view of the direct interfaces 16a, 16b after the direct interfaces 16a, 16b are physically connected. FIG. 4C illustrates a cross-sectional view of the direct interfaces 16a, 16b after the direct interfaces 16a, 16b are physically connected and after the locking mechanism 30 is actuated. As shown, in FIG. 4C, the actuators 34 of the locking mechanism 30 actuate the actuatable members 32 through the openings 40, 42 of the host device 12 and the peripheral device 10 to lock the peripheral device 10 to the host device 12.

It should be noted that, in other embodiments, the locking mechanism 30 may vary from the locking mechanism 30 shown in FIG. 4A-4C. For example, in some embodiments, the peripheral device 10 may instead include the locking mechanism 30. As another example, the locking mechanism 30 may be spring loaded instead of being actuated by an actuator.

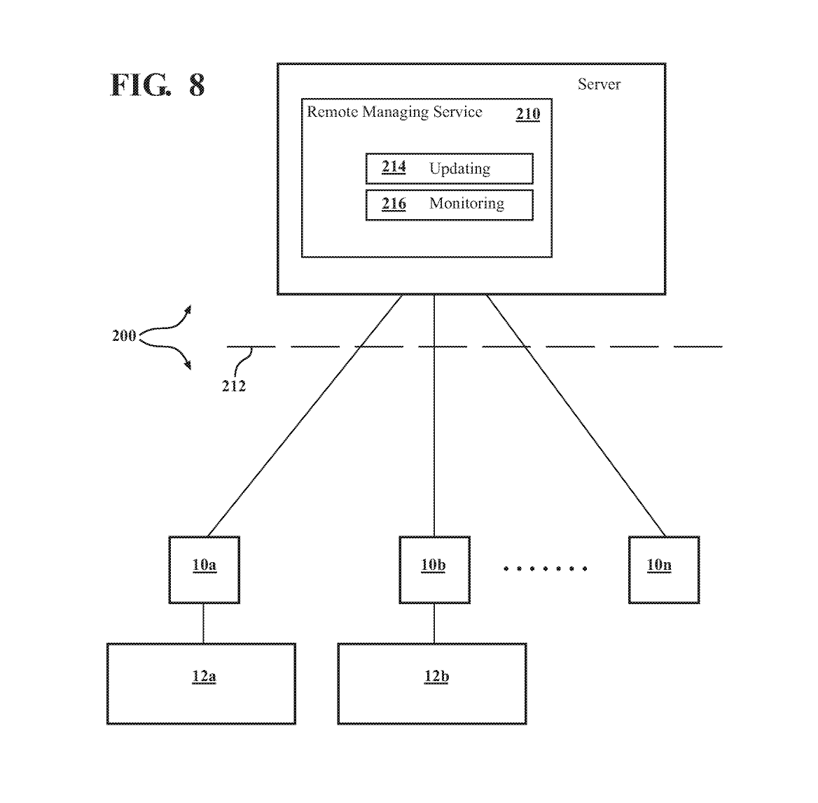

The locking mechanism 30 provides a physical level of security to the peripheral device 10 by preventing undesired removal of the peripheral device 10 from the host device 12 to prevent tampering of the peripheral device 10. For example, in one embodiment, the host device 12 or the peripheral device 10 may include a sensor, which may detect tampering. As such, if the sensor detects tampering of the peripheral device 10, the locking mechanism 30 may be actuated. In another embodiment, the locking mechanism 30 may be actuated after the peripheral device 10 and the host device 12 have been uniquely paired. In yet another embodiment, the locking mechanism 30 may be manually actuated by a user of the host device 12. In still another embodiment, the locking mechanism 30 may be actuated by a remote managing service, such as the remote managing service 210 (shown in FIG. 8 and further described herein). The remote managing service 210 may enable administrator(s) to monitor the host device 12 and the peripheral device 10. As such, if an administrator determines that a peripheral device 10 may be tampered with, the administrator may actuate the locking mechanism 30 via the remote managing service 210.

As shown in FIG. 2, the peripheral device 10 includes a network interface 44. The network interface 44 is a communication device/interface that is configured to establish connection between the peripheral device 10 and the network 18. The network interface 44 can transmit and/or receive data 20a, 20b via wired connection, wireless connection, or a combination thereof. The network interface 44 can be configured to operate according to any suitable connection method and/or respecting any suitable industry standard, such as, but not limited to, those described above, and/or any of the following: WiFi (IEEE 802.11), Wired Ethernet Local Area Network (LAN), Bluetooth (IEEE 802.15), Zigbee (IEEE 802.15.4), and any equivalents thereof.

Through the network interface 44, the peripheral device 10 can transmit/receive data 20a, 20b to/from a remote computer or server 50. The remote server 50 may be a computing device that is remotely located from the host device 12. The remote server 50 may communicate through the network 18 using any wired or wireless network protocol or technique, such as those described herein. The host device 12 generally desires transmission/reception of the data 20a, 20b to/from the remote server 50. Although the term “server” is used to describe the remote server 50, it should be understood that the remote server 50 may comprise any network enabled computing device, such as desktop PC, laptop, tablet, smartphone, enterprise computing system, etc. In any instance, the remote server 50 is generally the intended source/target of communication for the host device 12 network operations.

In some embodiments, the peripheral device 10 may comprise an intrusion mitigation feature, such as a circuit breaker 52. As shown in FIG. 2, the circuit breaker 52 is coupled between the processor 40b and the network interface 44. The circuit breaker 52 comprises any mechanical, electromechanical, electrical, and/or software implemented feature that is configured to abruptly disable one or more operations of the peripheral device 10 for security purposes. Examples of the circuit breaker 52 include, but are not limited to, a fuse, a kill switch, a surge generator, a physical switch, software code configured to eliminate data or access, or any other suitable hardware/software configured to disable operation. The circuit breaker 52 may utilize heat generation to destroy any intended circuit. Examples of criteria for triggering of the circuit breaker 52 are described below.

In some embodiments, the peripheral device 10 may include a location tracker 74b and a location tracker 74a may be disposed on the host device 12. In one embodiment, the peripheral device 10 uses a “local tracking technique” to determine its location if the location tracker 74a and the location tracker 74b are within a proximity of one another and are able to communicate with one another. In another embodiment, the peripheral device 10 uses a “remote tracking technique” to determine its location if the location tracker 74b is connected to a network. These techniques for determining the location of the peripheral device 10 are further described herein.

Furthermore, the location trackers 74a, 74b may be embodied by any software, hardware, or any combination thereof. For example, location trackers 74a, 74b may include RF transmitters and receivers, GPS receivers, WiFi positioning systems, or any other devices suitable for determining a location of a device.

Additionally, as shown in FIG. 2, the location tracker 74b of the peripheral device 10 may be coupled to the circuit breaker 52. As such, the circuit breaker 52 may abruptly disable one or more operations of the peripheral device 10 based on the location of the peripheral device 10. For example, in some instances, the circuit breaker 52 may eliminate data from memory component 22b or access to the data from memory component 22b if the peripheral device 10 is no longer on-premises at a location of the host device 12. Techniques for disabling one or more operations of the peripheral device 10 based on the location of the peripheral device 10 are also further described herein.

### III. Advanced Cyber-Security Features

Described below are various examples of access and security features afforded by the peripheral device 10. These features are designed to securely control access of the host device 12 to the proper peripheral device 10 as well as access of the host device 12 to the network 18 and remote server 50. These features further ensure that the host device 12 is protected, any data 20a, 20b transmission to/from the host device 12 through the network 18 is protected, and any malicious or accidental intrusions will be prevented.

A. Unique Device ID Pairing and Authentication

As described above, a single peripheral device 10 and a single host device 12 are uniquely paired using hardware and/or software to work with each other. In other words, the peripheral device 10 is prevented from use or re-use with another host device 12 to provide cyber-security services to such other host devices 12. Furthermore, the single host device 12 is uniquely configured to accept only the single peripheral device 10 which is paired with the single host device 12. Through these techniques, the devices 10, 12 are hardware specific devices relative to one another.

In one embodiment, such unique pairing is implemented using one or more unique device identifiers (UDID), as shown in FIG. 2. The UDID is any unique identification data associated solely with a single device. The UDID may be numeric, alphanumeric, any combination thereof, or any complex data string having any number of bits or characters. The UDID may comprise a serial number, a randomly generated number, and the UDID may continuously be changed by the respective device 10, 12 for added security.

As shown in FIG. 2, the host device 12 and the peripheral device 10 each comprise their own UDID. The UDID of the host device 12 uniquely identifies the host device 12 and the UDID of the peripheral device 10 uniquely identifies the peripheral device 10. In other words, the UDID of the host device 12 is unlike any UDID of any other host device. Also, the UDID of the peripheral device 10 is unlike any UDID of any other peripheral device. In some examples, the UDIDs identify sub-components of the devices 10, 12, such as the direct interfaces 16a, 16b, rather than the devices 10, 12 as a whole.

As shown in the example of FIG. 2, the UDID of the host device 12 is stored in the memory component 22a of the host device 12 and the UDID of the peripheral device 10 is stored in the memory component 22b of the peripheral device 10. Additionally or alternatively, the UDID of the host device 12 is stored on the memory component 22b of the peripheral device 10 and the UDID of the peripheral device 10 is stored on the memory component 22a of the host device 12. The UDIDs may be stored in any appropriate locations to enable comparison of the same for authentication purposes.

As shown in FIG. 2, the peripheral device 10 comprises, at 54, a software module for implementing UDID evaluation. The UDID evaluation module 54 comprises computer-executable instructions stored on the memory component 22b of the peripheral device 10 and being executable by the processor 40b of the peripheral device 10. Although the UDID evaluation module 54 is shown in the peripheral device 10 in FIG. 2, the host device 12 may comprise a similar module stored in memory 22a to enable the host device 12 to implement UDID evaluation.

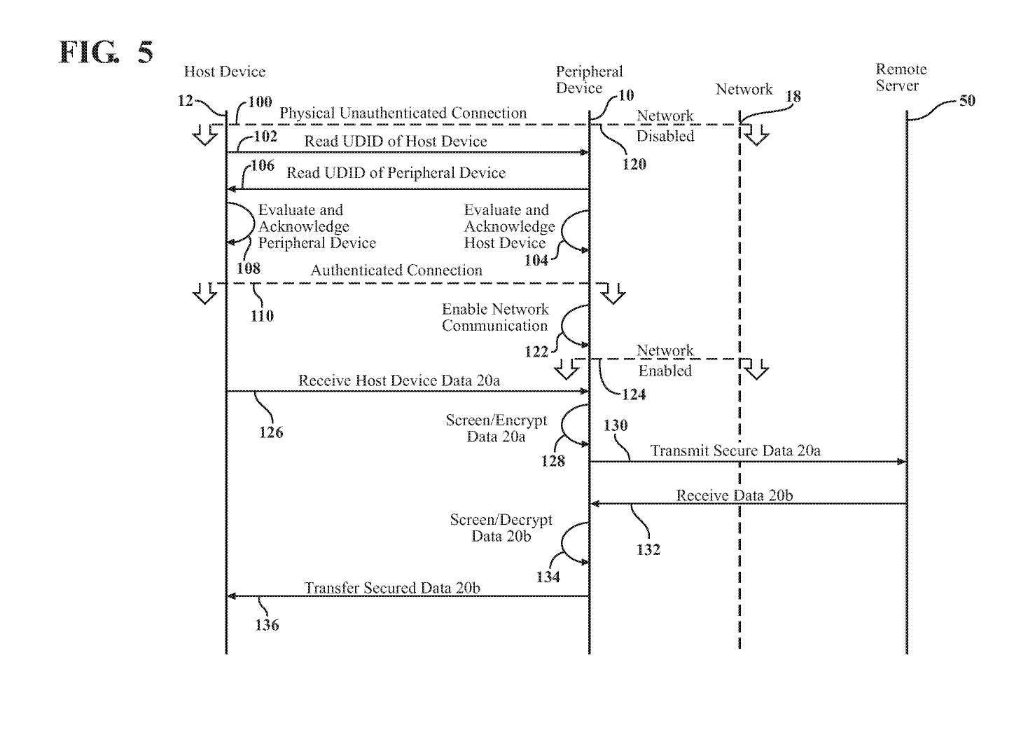

Referring to the sequence diagram of FIG. 5, methods associated with the host device 12, peripheral device 10, network 18 and remote server 50 are illustrated and described, including methods associated with the UDID evaluation module 54. Although the steps shown in diagram FIG. 5 are presented in a certain order, the sequence of steps may be executed in orders other than those shown.

At step 100, the peripheral device 10 is physically coupled to the host device 12. In other words, the direct interfaces 16a, 16b are connected to one another. However, despite such connection, the devices 10, 12 have not been authenticated relative to one another. Thus, the host device 12 and peripheral device 10 may consider the other to be a foreign device, unless authenticated otherwise. As will be described below, at this step 100, cyber-security capabilities of the peripheral device 10 are disabled. Communication between the devices 10, 12 at this step 100 may be strictly limited to communication relating solely to authentication.

At step 102, the UDID evaluation module 54 of the peripheral device 10 detects the physical connection of the direct interfaces 16a, 16b from step 100. Detection of the physical connection triggers the UDID evaluation module 54 to request and read the UDID of the host device 12 at step 102.

At step 104, the UDID of the host device 12 is evaluated by the UDID evaluation module 54 to determine whether this host device 12 is the uniquely paired host device 12 for this peripheral device 10. The UDID of the host device 12 may be stored in the memory component 22b of the peripheral device 10 prior to such evaluation. If the UDID that is read matches the previously stored UDID, the UDID evaluation module 54 determines a match exists, and the peripheral device 10 authenticates the host device 12.

Additionally or alternatively, at step 106, detection of the physical connection triggers the host device 12 to request and read the UDID of the peripheral device 10. At step 108, the UDID of the peripheral device 10 is evaluated by the host device 12 to determine whether this peripheral device 10 is the uniquely paired peripheral device 10 for this host device 12. The UDID of the peripheral device 10 may be stored in the memory component 22a of the host device 12 prior to such evaluation. If the read UDID matches the previously stored UDID, the host device 12 determines a match exists, and the host device 12 authenticates the peripheral device 10. The UDID pairing process may differ from the steps described herein and equivalents of the UDID pairing process are fully contemplated.

Acknowledgement of the evaluated UDID or UDIDs, as described above, enables the devices 10, 12 to establish open and secure bi-directional communication through the direct interfaces 16a, 16b, as shown at step 110. Cyber-security capabilities of the peripheral device 10 provided for the host device 12 are enabled.

On the other hand, if there is a mismatch between the UDIDs, either as determined by the peripheral device 10 (step 102) and/or as determined by the host device 12 (step 106), the authentication process fails and authenticated communication between the devices 10, 12 is prohibited. Each device 10, 12 may store in memory 22a, 22b an event log, which can record information related to failed authentication attempts. Such information may comprise the UDID of the attempting device 10, 12 and the date/time of such attempt. In some instances, one or more of the direct interfaces 16a, 16b may lock down/self-destruct after a specified number of invalid attempts.

In some instances, the UDIDs may be evaluated by the direct interfaces 16a, 16b themselves. In such examples, the direct interfaces 16a, 16b may comprise added components (such as memory and logic means) to enable reading and evaluation of the UDIDs at the interface-level. Such configuration enables the devices 10, 12 to be hardware specific with respect to one another. The UDIDs in this example may relate to identification of the devices 10, 12, as a whole, or identification of the direct interfaces 16a, 16b.

With respect to the medical industry, the described UDID pairing process provides transmission security from the host device 12 to the known peripheral device 10 to aide in HIPAA compliance.

B. Network Access

With continued reference to FIG. 5, network access control features provided by the peripheral device 10 are described.

As described, the host device 12 is configured to transmit/receive data 20a, 20b through the network 18 to/from the remote server 50. As such, the host device 12 is capable of performing network operations that require presence of a connection to the network 18.

The host device 12 is also configured to perform local operations that do not require connection to the network 18, and more specifically, transmission/reception of data 20a, 20b through the network 18. Such local operations are unaffected by the absence of network 18 connection and will vary depending on the configuration/application/field of the host device 12. For example, with respect to the surgical robotic system 26 of FIG. 1, the robotic manipulator 28 may perform locally determined motions based on local tracking determined by the manipulator computer 30 and navigation computer 34, absent any communication over the network 18. Other examples of local operations of the host device 12 are contemplated other than those described herein.

For cyber-security purposes, there is a concern related to the network operations of the host device 12. Accordingly, the peripheral device 10 is provided as a gateway to enable the host device 12 to connect and communicate over the network 18. The peripheral device 10 acts as a secure intermediary between the host device 12 and the remote server 50.

As shown in FIG. 5, the host device 12 and peripheral device 10 relationship is configured such that the host device 12 is prevented from accessing the network 18 absent secure authentication of the corresponding peripheral device 10. As such, at step 100, when the devices 10, 12 are physically connected at the direct interfaces 16a, 16b, but there is no authentication between the devices 10, 12, the network capabilities of the host device 12 are disabled, as shown at step 120. Here, the host device 12 is entirely disconnected from the network 18 and is unable to transmit/receive data 20a, 20b through the network 18.

In one embodiment, the host device 12 is configured internally to prevent such network 18 access absent authentication and irrespective of the peripheral device 10. For example, if authentication with the peripheral device 10 fails, the host device 12 may disable any internal network communication devices. Additionally or alternatively, at step 120, the peripheral device 10 disables the network interface 44 to ensure network communication is disabled.

Although the network is disabled at step 120, the host device 12 may nevertheless perform local operations not requiring network 18 communication.

Once authenticated connection between the devices 10, 12 is established at step 110, the peripheral device 10 triggers enablement of network 18 communication for the host device 12 at step 122. The peripheral device 10, in one example, enables network 18 communication by activating the network interface 44 and linking the peripheral device 10 to remote server 50 over the network 18. The network 18 communication is enabled at step 124, and will remain so, until one of the devices 10, 12 determines otherwise, e.g., to prevent cyber intrusions.

After the network 18 communication is enabled at step 124, the host device 12 will utilize the peripheral device 10 to facilitate communication of data 20a, 20b through the network 18. In other words, the host device 12 cannot otherwise communicate through the network 18 absent the authenticated connection with the peripheral device 10 (at step 110) and absent the peripheral device 10 establishing network 18 communication on behalf of the host device 12 (at steps 122, 124). Any data 20a transmitted from the host device 12 must pass through the direct interfaces 16a, 16b and through the network interface 44 of the peripheral device 10 before reaching the remote server 50 through the network 18. Conversely, any data 20b transmitted to the host device 12 from the remote server 50 must pass through the network interface 44 of the peripheral device 10 and through the direct interfaces 16a, 16b before reaching host device 12.

Network access features implemented by the devices 10, 12 may differ from the techniques described herein and equivalents of the network access features are fully contemplated.

C. Interface Hardware Encryption

With authentication established between the devices 10, 12 (at step 110) and with network communication for the host device 12 established by the peripheral device 10 (at steps 122, 124), techniques are described herein to enable encryption and secure transmission/reception of data 20a, 20b from/to the host device 12 across the network 18.

In one embodiment, encryption and secure transmission/reception of data 20a, 20b is performed at a local level, i.e., between the devices 10, 12. For example, the data 20a transmitted from the host device 12 to the peripheral device 10, and vice-versa, through the direct interfaces 16a, 16b, may be encrypted/decrypted. This may be done as an added security measure despite authentication of the devices 10, 12, as described.

In one example, encryption/decryption is performed using hardware-based techniques and without software involvement. For instance, one or more of the direct interfaces 16a, 16b may be configured with a crypto-chip 58a, 58b, respectively, as shown in FIG. 2. The crypto-chips 58a, 58b are integrated circuits configured to automatically encrypt/decrypt the data 20a, 20b passing between the crypto-chips 58a, 58b through the direct interfaces 16a, 16b. The crypto-chips 58a, 58b may manage encryption/decryption keys to automatically encrypt/decrypt the data 20a, 20b. In one example, the crypto-chips 58a, 58b include one or more of Advance Encryption Standard (AES) chips, such as 256-bit AES chips, Secure Hash Algorithm (SHA) chips, and Elliptic Curve Cryptography (ECC) chips, or equivalents thereof.

Although the crypto-chips 58a, 58b are illustrated as sub-components of the direct interfaces 16a, 16b in FIG. 2, it should be understood that the crypto-chips 58a, 58b may be coupled to the direct interfaces 16a, 16b but not necessarily sub-components thereof. Moreover, although hardware techniques have been described for encrypting data between the devices 10, 12, such hardware techniques may be combined with software-based techniques.

D. Network Encryption

The peripheral device 10 further provides the host device 12 with network encryption/decryption services. That is, the peripheral device 10 is configured to encrypt data 20a for transmission to the remote server 50 over the network 18 and to decrypt data 20b received from the remote server 50 over the network 18.

As shown in FIG. 2, the peripheral device 10 comprises, at 60, a software module for implementing network encryption. The network encryption module 60 comprises computer-executable instructions stored on the memory component 22b of the peripheral device 10 and being executable by the processor 40b of the peripheral device 10.

Examples of encryption and secure transmission techniques that can be employed by the peripheral device 10 include, but are not limited to, any version of the following: Wireless Intrusion Prevention System (WIPS), Wired Equivalent Privacy (WEP), Wi-Fi Protected Access (WPA), Extensible Authentication Protocol (EAP), End-to-end encryption, Temporal Key Integrity Protocol (TKIP), Advanced Encryption Standard (AES) methods, Virtual Private Networking (VPN) and any combinations and equivalents thereof.

Referring back to FIG. 5, one example is shown for purposes of illustrating aspects of the network encryption services of the peripheral device 10. The host device 12 desires to transmit (outbound) data 20a from the memory component 22a to the remote server 50, over the network 18. As such, at step 126, the host device 12 transfers, and the peripheral device 10 receives, the outbound data 20a. As described, this outbound data 20a is transferred across the direct interfaces 16a, 16b, and may be encrypted/decrypted using the techniques described above.

Once the outbound data 20a is received by the peripheral device 10, the peripheral device 10 executes the network encryption module 60 to prepare the outbound data 20a for transmission. The network encryption module 60 encrypts and secures the outbound data 20a at step 128. At step 130, the peripheral device 10 employs the network interface 44 to transmit the encrypted outbound data 20a to the remote server 50 across the network 18. Encrypting the outbound data 20a using the peripheral device 10 prevents the outbound data 20a from discovery over the network 18. Additionally or alternatively, the data 20a may be screened by external firewall capabilities of the peripheral device 10 to control flow of outbound data 20a, as described below.

Conversely, the host device 12 may desire to receive (inbound) data 20b from the remote server 50, over the network 18. As such, at step 132, the remote server 50 sends the inbound data 20b through the network 18 and the peripheral device 10 receives the inbound data 20b using the network interface 44.

Inbound data 20b may be encrypted or may be unsecured. If the inbound data 20b is encrypted, the peripheral device 10 executes the network encryption module 60 to prepare the inbound data 20b for transfer to the host device 12. For example, the network encryption module 60 may decrypt the inbound data 20b at step 134. Additionally or alternatively, the inbound data 20b may be screened by external firewall capabilities of the peripheral device 10 to control flow of inbound data 20b, as described below.

At step 136, the outbound data 20a is transferred across the direct interfaces 16a, 16b to the host device 12 and may be encrypted/decrypted using the techniques described above.

By using hardware encryption and network encryption, data 20a, 20b transmitted to/from the host device 12 is secured throughout the entire transmission path between the host device 12 and the remote server 50.

Network encryption techniques and actions other than those described herein are fully contemplated and that network encryption techniques and actions are not limited solely to those shown in the example in FIG. 5.

E. Firewall Capabilities

In addition to hardware and network encryption, as described, the peripheral device 10 may also afford the host device 12 with firewall capabilities. Specifically, the peripheral device 10 provides the host device 12 with an external firewall, i.e., a network security measure/device configured to monitor transmission flows of data 20a, 20b from/to the host device 12 over the network 18 and configured to implement security rules or policies for permitting and/or allowing transmission of data 20a, 20b from/to the host device 12. The external firewall ensures that data 20b flowing into the host device 12 from the network 18 is coming from a trusted/safe source and data 20a flowing out of the host device 12 to the network 18 is going to a trusted/safe source. The types of data 20a, 20b flows monitored by the firewall module 62 include, but are not limited to, flows from any one or more of File Transfer Protocol (FTP), Secure Sockets Layer (SSL), Secure Shell Protocol (SSH), Domain Name Server Protocol (DNS), Hypertext Transfer Protocol (HTTP), Hypertext Transfer Protocol Secure (HTTPS), and the like.

The external firewall further checks the inbound data 20b for unsafe packets, command requests, files or applications, or any other data that may cause unsafe, unauthorized, malicious, unintended or otherwise undesirable access to or control of the host device 12. Examples of unsafe applications include viruses, malware, ransomware, etc. The peripheral device 10 prevents the same from reaching the host device 12. The firewall module 62 analyzes the data 20b relative to the security routines/policies to determine whether the data 20b is compliant with the same. When activated, all data 20a, 20b to/from the network 18 must pass through the external firewall. In one example, the external firewall is actively monitoring data 20a, 20b flows so long as the devices 10, 12 remain connected and authenticated and the network 18 connection is enabled.

The firewall module 62 may be configured to analyze the data 20a, 20b relative to security routines/policies using a number of methods. For example, the external firewall may be configured to analyze the data 20a, 20b for unsafe packets and unsafe applications based on an adaptive learning algorithm. For instance, the external firewall may determine whether the data 20a, 20b may lead to a security breach based on previously received data 20a, 20b. In one such instance, the remote server 50 or the processor 40b may analyze data 20a, 20b that was received during past data breaches. The firewall module 62 may then use this analysis to determine whether data 20a/20b flowing from/to the host device 12 may cause a data breach.

The firewall module 62 comprises computer-executable instructions stored on the memory component 22b of the peripheral device 10 and being executable by the processor 40b of the peripheral device 10. The firewall module 62 may work with the network interface 44 of the peripheral device 10 to implement the external firewall. The external firewall may include, or be any one or more of: a packet filtering firewall, an application-gateway firewall, a VPN firewall, a circuit-gateway firewall, or any combination thereof. The external firewall can be a network layer firewall, an application-layer firewall, a proxy server, or any other suitable type of firewall.

As described, the devices 10, 12 are hardware specific devices with respect to one another by virtue of the described techniques. Such hardware specificity is further attributed to the external firewall. In other words, the external firewall service of the peripheral device 10 is uniquely paired to the host device 12 and cannot be used or re-used with another host device 12 to provide external firewall services to such other host devices 12. In turn, the peripheral device 10 is configured to provide the host device 12 with hardwired packet-level security.

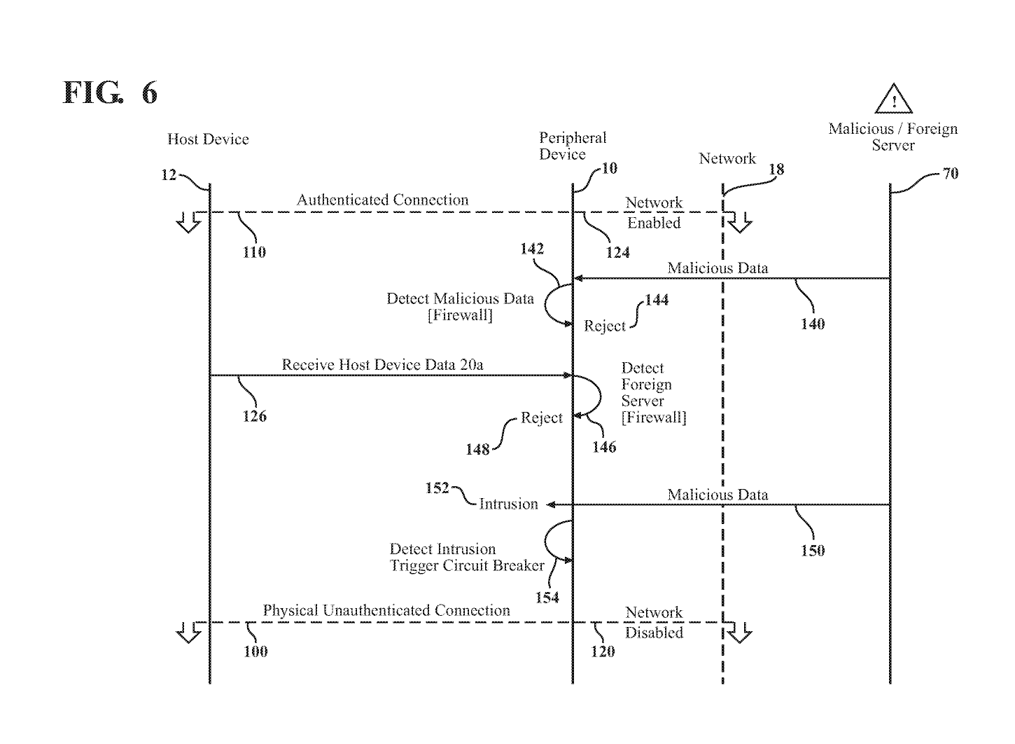

Referring to FIG. 6, another example sequence diagram is provided for purposes of illustrating further cyber-security features of the peripheral device 10. In this example, a foreign server 70 is substituted for the remote server 50 of FIG. 5, for illustration purposes. Unlike the remote server 50, the foreign server 70 is a malicious, unintended, accidental, or otherwise undesired server with respect to the host device 12. As such, the host device 12 should not transmit/receive data 20a, 20b to/from the foreign server 70.

At the outset, the devices 10, 12 have established an authenticated connection (step 110) and network 18 communication is enabled (step 124). In this example, the foreign server 70 has maliciously gained access to the network 18. At step 140, the foreign server 140 transmits malicious data that is intended to reach the host device 12. Absent intervention from the peripheral device 10, the malicious data will reach the host device 12. However, at step 142, the firewall module 62 of the peripheral device 10 detects the malicious data using the external firewall. At step 142, the firewall module 62, after detecting presence of the malicious data, prevents the malicious data from passing through the peripheral device 10 and reaching the host device 12.

With respect to outbound firewall features, at step 126, the host device 12 transfers, and the peripheral device 10 receives, the outbound data 20a for intended transmission to the remote server 50. Absent intervention from the peripheral device 10, the outbound data 20a will be intercepted by the foreign server 70. However, in this example, at step 146, the firewall module 62 of the peripheral device 10 detects presence of the foreign server 70 on the network 18. At step 148, the firewall module 62, after detecting presence of the foreign server 70, prevents the outbound data 20a from passing through the network 18 and reaching the foreign server 70.

External firewall techniques and actions other than those described herein are fully contemplated and that external firewall techniques and actions are not limited solely to those shown in the example in FIG. 6.

F. IP Masking

As shown in FIG. 2, the peripheral device 10 may comprise an Internet Protocol (IP) masking module 72. The IP masking module 72 comprises computer-executable instructions stored on the memory component 22b of the peripheral device 10 and being executable by the processor 40b of the peripheral device 10. The IP masking module 72 may invoke other hardware for performing the techniques described herein.

To communicate with the remote server 50 over the network 18, the host device 12 comprises a unique IP address including an address of the network 18 and an address of the host device 12. Exposure of the host device 12 IP address raises privacy concerns relating to potential intrusions from foreign servers 70. Absent involvement from the peripheral device 10, the foreign server 70 may use an exposed IP address to identify the type of host device 12, the location of the host device 12, monitor activities of the host device 12, etc.

To provide further security for the host device 12, the peripheral device 10 is configured to execute the IP masking module 72 to mask or hide the IP address of the host device 12. The IP masking module 72 may employ any suitable technique for masking the IP address, including, but not limited to, subnet masking, address encryption, IP hiding proxy, or the like. Through this technique, the foreign server 70 will be unable to detect the IP address of the host device 12. Authorized servers, such as the remote server 50, may include corresponding means of unmasking, decrypting, un-hiding the IP address of the host device 12.

As described, the devices 10, 12 may be hardware specific devices with respect to one another by virtue of the described techniques. Such hardware specificity is further attributed to IP masking. In other words, the IP masking service of the peripheral device 10 is uniquely paired to the host device 12 and cannot be used or re-used with another host device 12 to provide IP masking services to such other host devices 12. In turn, the peripheral device 10 is configured to provide the host device 12 with hardwired IP masking to protect the host device 12 from packet-level intrusions.

The techniques described above with respect to IP masking for the host device 12 may be applied fully and additionally to IP masking of the peripheral device 10. IP masking techniques and actions other than those described herein are fully contemplated and that IP masking techniques and actions are not limited solely to those described herein.

G. Circuit Breaking Techniques

As described above, the peripheral device 10 may comprise the circuit breaker 52. The circuit breaker 52 may be embodied by any software, hardware, or any combination thereof.

In general, the circuit breaker 52 is configured to disable one or more operations of the peripheral device 10 for security purposes. Such disabling may be temporary and resettable, e.g., automatically reset after lapse of a specified time or manually reset. Alternatively, disabling may be permanent resulting in physical damage to the peripheral device 10.

Events that trigger the circuit breaker 52 are detectable by the processor 40b of the peripheral device 10. In one example, the triggering event is an attempt to physically tamper with the peripheral device 10. The peripheral device 10 may include a tamper detector, such as a sensor (temperature, radiation, voltage, power, moisture/humidity), switch (magnetic, pressure, electrical), or any other type of circuitry to enable detection of physical tampering of the peripheral device 10. Such features may be disposed within, or otherwise coupled to the housing 19 of the peripheral device 10. Signals from such tamper detectors may be processed and analyzed by the processor 40b to determine whether a threshold has been exceeded to trigger the circuit breaker 52. With an event as significant as physical tampering, permanent destruction of the peripheral device 10 by the circuit breaker 52 may be appropriate. The peripheral device 10 may be discarded after permanent destruction.

In another example, the triggering event is an attempted network-based intrusion of the peripheral device 10 and/or host device 12 from the foreign server 70. In such instances, the processor 40b, or the firewall module 62 may detect a packet-level intrusion through the network 18. One example of this situation is illustrated in FIG. 6. At step 150, the foreign server 70 attempts to tamper with the peripheral device 10 and/or host device 12 by transmitting malicious data. In this example, although unlikely, we assume that the malicious data has intruded the peripheral device 10 at a packet-level, thereby breaching the external firewall, as shown at 152. At 154, the peripheral device 10 detects the pack-level intrusion and triggers the circuit breaker 52 immediately. Triggering of the circuit breaker 52, according to one example, disables operation of the network interface 44. By doing so, the circuit breaker 52 is configured to disable transmission of data 20a, 20b to/from the peripheral device 10 relative to the network 18. Accordingly, after disabling the network interface 44, the network communication is disabled, as shown at 120. In another example, the circuit breaker 52 disables the direct interface 16b, or any downstream component that facilitates authenticated connection with the host device 12. In such instances, the circuit breaker 52 may additionally, or alternatively, un-authenticate connection with the host device 12. In yet another example, the circuit breaker 52 operates to erase all sensitive data from the peripheral device 10 that may be from the host device 12 or that may be exploited to gain access to the host device 12. The circuit breaker 52 and techniques related to the same may be designed to comply with FIPS 140-2, Security levels 3 and 4.

In yet another example, the triggering event occurs when the peripheral device 10 goes through multiple power cycles within a short time frame. In one instance, a power cycle may occur when the peripheral device 10 is plugged into and removed from a host device 12. Therefore, when the peripheral device 10 is plugged into and removed from a host device 12 multiple times with the short time frame, the circuit breaker 52 may be triggered. To detect this triggering event, the peripheral device 10, such as the peripheral device 10 in FIG. 2, includes a real-time clock 56, which is coupled to the direct interface 16b and to the processor 40b. As such, the processor 40b receives a time stamp from the real-time clock 56 each time the direct interface 16b is plugged into the direct interface 16a of the host device 12 (i.e. for each power cycle). The processor 40b then saves the time stamp into the memory 22b. In this way, a triggering event may be detected when the processor 40b determines, based on the time stamps saved into the memory 22b, that the peripheral device 10 has gone through a threshold number of power cycles within the short time frame.

Other triggering events besides those described herein may trigger the circuit breaker 52 and such other triggering events are fully contemplated. Furthermore, although the term “circuit breaker” is utilized herein, it should be understood that the function of disabling operations of certain features of the peripheral device 10 may be executed using software/hardware not necessarily including a “circuit” or a “breaker”.

The techniques described above, which provide immediate response to intrusion for the peripheral device 10 may be applied fully and additionally to aspects of the host device 12. Intrusion mitigation software/hardware, techniques, and actions other than those described herein are fully contemplated and that intrusion mitigation techniques and actions are not limited solely to those described herein.

H. Location Tracking Techniques

As described above, the peripheral device 10 may include the location tracker 74b and the location tracker 74a may be disposed on the host device 12 for determining the location of the peripheral device 10. Also previously described, a local tracking technique and a remote tracking technique may be used to determine the location of the peripheral device 10.

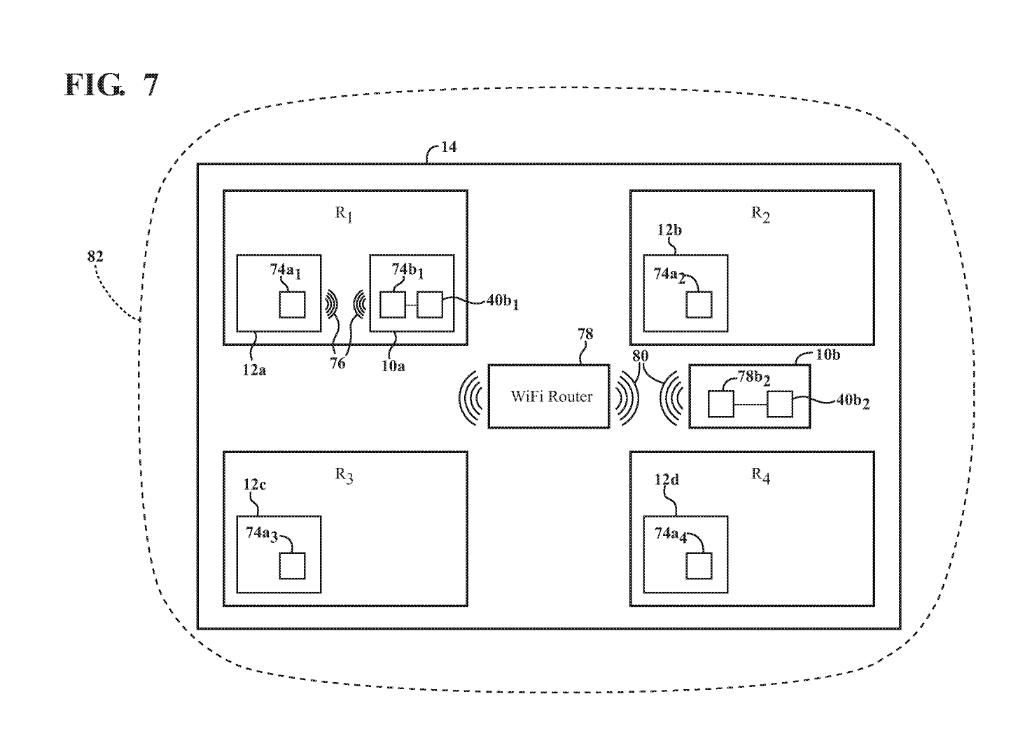

To illustrate the techniques for determining the location of the peripheral device 10, FIG. 7 illustrates an example embodiment of a site 14 (e.g., a hospital facility), which includes rooms R₁-R₄, host devices 12a-12d, and peripheral devices 10a and 10b. As shown, each peripheral device 10a, 10b includes a location tracker 74b₁, 74b₂, which is coupled to a processor 40b₁, 40b₂. Also shown, each room R₁-R₄ includes a host device 12a-12d and a location tracker 74a₁-74a₄ is disposed on each host device 12a-12d.

As previously stated, the peripheral device 10 may determine the location of the peripheral device 10 using the local tracking technique and the remote tracking technique. The local tracking technique includes a step of determining the location of a peripheral device 10 when the location tracker 74a disposed on the host device 12 and the location tracker 74b of the peripheral device 10 are within a proximity of one another. The remote tracking technique includes a step of determining the location of a peripheral device 10 when the location tracker 74b of the peripheral device 10 is connected to a network. The network connection may be facilitated either through connection of the peripheral device 10 to the network or through connection of the host device 12 to the network.

Additionally, as will be described further herein, the local tracking technique may be used to determine whether a peripheral device 10 is located within a certain location of a site, such as within a room of a hospital facility. In contrast, the remote tracking technique may be used to determine whether the peripheral device 10 is located on-premises at a site, such as on-premises at the hospital facility.

The local tracking technique is shown in FIG. 7 using the location tracker 74a₁ disposed on the host device 12a and the location tracker 74b₁ of the peripheral device 10a. As shown, the location trackers 74a₁, 74b₁ are within a proximity of one another and are able to communicate with one another. In the embodiment of FIG. 7, the location tracker 74a₁ is a passive RFID tag disposed on the host device 12a and the location tracker 74b₁ is an RFID reader. As such, the location trackers 74a₁, 74b₁ may communicate using RF signals 76 when the location trackers 74a₁, 74b₁ are within a proximity of one another. The processor 40b₁ of the peripheral device 10a may determine the location of the peripheral device 10a based on the RF signals 76. For example, the processor 40b₁ may determine that the peripheral device 10a is in the same room as the host device 12a and/or a certain distance away.

In other embodiments of the local tracking technique, the location tracker 74a may be disposed on an object other than a host device 12. For example, in FIG. 7, the location trackers 74a₁-74a₄ may be disposed on a wall of rooms R₁-R₄. As such, when the location tracker 74b of a peripheral device 10 and a location tracker 74a₁-74a₄ are within a proximity, the processor 40b of the peripheral device 10 may determine its location in reference to rooms R₁-R₄. For instance, the location tracker 74a₁ may be a passive RFID tag disposed on a wall of room R₁ and the location tracker 74b₁ of the peripheral device 10a may be an RFID reader. Therefore, once location trackers 74a₁, 74b₁ are within a proximity of one another and communicate using RF signals, the processor 40a may determine that the peripheral device 10a is in room R₁.

In the above embodiments of the local tracking technique, any location tracker 74a and any location tracker 74b may communicate when one is within a proximity of the other. For example, referring to FIG. 7, location tracker 74a₃ and location tracker 74b₂ of peripheral device 10b may communicate when one is within a proximity of the other. As such, in embodiments where the location tracker 74a3 is disposed on the host device 12c (such as the embodiment of FIG. 7), the processor 40b₂ may determine that the peripheral device 10b is within a proximity of the host device 12c. In embodiments where the location tracker 74a₃ is disposed on a wall in room R₃, the processor 40b₂ may determine that the peripheral device 10b is in room R₃.

The location trackers 74a, 74b may include any suitable software, hardware, or combinations thereof for communicating with one another when the location trackers 74a, 74b are within a proximity of one another. For example, the location trackers 74a, 74b may include a variety of devices, which may communicate using a variety of communication protocols. In the embodiment of FIG. 7, the location tracker 74a₁ is a passive RFID tag and the location tracker 74b₁ is an RFID reader such that the location trackers 74a₁, 74b₁ communicate using RF signals 76. However, in other embodiments, the location trackers 74a, 74b may include devices other than RF transmitters/receivers and may communicate using different communication protocols. For instance, the location trackers 74a, 74b may include devices which communicate using Bluetooth (IEEE 802.15), Zigbee (IEEE 802.15.4), Infrared, Near-Field Communication, or any other suitable communication protocol.

In the local tracking technique, the location of a peripheral device 10 is determined when location trackers 74a, 74b are within a proximity of one another. This proximity may be defined as a distance between the location trackers 74a, 74b, which allows the location tracker 74a to communicate with the location tracker 74b. Therefore, the proximity may be defined differently depending on the communication protocol used by the location trackers 74a, 74b. For instance, RF signals have a standard range of communication of approximately 10 feet and Bluetooth has a standard range of communication of approximately 100 meters. Therefore, in an embodiment where the location trackers 74a, 74b communicate via Bluetooth, the proximity may be defined as a larger distance.

Using the remote tracking technique, the peripheral device 10 may determine its location and whether it is on-premises at a site if the location tracker 74b is connected to a network. However, the peripheral device 10 may determine whether it is on-premises at a site using two embodiments of the remote tracking technique. In the first embodiment, the peripheral device 10 determines whether it is on-premises at a site based on whether it is within a range of the network. In the second embodiment of the remote tracking technique, the peripheral device 10 determines whether it is on-premises at a site by determining a set of coordinates representing its location and comparing the coordinates to a location of the site.

In the remote tracking technique, the network may be any network suitable for determining a location of the peripheral device 10. For example, the network may be a WiFi network, a cellular network, a Global Positioning System (GPS), or any other suitable network. Additionally, as shown in FIG. 2, the location tracker 74b of the peripheral device 10 may be coupled to the network interface 44. As such, the location tracker 74b may connect to the WiFi network, the cellular network, the GPS, or any other suitable network via the network interface 44.

The first embodiment of the remote tracking technique is shown in FIG. 7 using the peripheral device 10b and the WiFi router 78. As shown, the location tracker 74b₂ of the peripheral device 10b communicates with the WiFi router 78 via a WiFi signal 80, enabling the processor 40b₂ of the peripheral device 10b to determine its own location. In FIG. 7, the peripheral device 10b determines whether it is on-premises at the site 14 based on whether it is within range of the WiFi router 78. Referring to FIG. 7, the range of the WiFi router 78 is illustrated using WiFi range 82, which is similar to a size of the site 14. As such, when the peripheral device 10b is in the WiFi range 82 and is connected to the WiFi router 78, the processor 40b₂ determines that the peripheral device 10b is on-premises at the site 14. In contrast, when the peripheral device 10b is outside the WiFi range 82, the processor 40b₂ determines that the peripheral device 10b is not on-premises at the site 14.

In the second embodiment of the remote tracking technique (not shown in FIG. 7), the peripheral device 10b may determine whether it is on-premises at the site 14 by determining a set of coordinates representing its location and comparing the coordinates to a location of the site. For example, in one such embodiment, the location tracker 40b₂ of the peripheral device 10b may be connected to a GPS. As such, the processor 40b₂ may determine a longitude and latitude of the peripheral device 10b based on the GPS connection and compare the longitude and latitude of the peripheral device 10b to a longitude and latitude of the site 14. In this way, the processor 40b₂ may determine whether or not the peripheral device 10b is located on-premises at the site 14.

Either or both of the local and remote tracking techniques may be used to determine the location of the peripheral device 10. For example, in an embodiment where the location tracker 74b of the peripheral device 10 is able to connect to the WiFi router 78 and the location tracker 74b is able to communicate with a location tracker 74a using RF signals 76, both the local and remote tracking techniques may be used. In an embodiment where the location tracker 74b is able to connect to the WiFi router 78, but the host devices 12 omit the location tracker 74a, the remote tracking technique may be used and the local tracking technique may be omitted. In an embodiment where the WiFi router 78 is omitted, but the location tracker 74b is able to communicate with a location tracker 74a using RF signals 76, the remote tracking technique may be omitted and the local tracking technique may be used.

The local and remote tracking techniques may be used in conjunction with the circuit breaker 52 to abruptly disable one or more operations of the peripheral device 10 based on the location of the peripheral device 10. For example, in some instances, the circuit breaker 52 may eliminate data from memory component 22b or access to the data from memory component 22b of the location tracker 74b based on the location of the peripheral device 10.

In embodiments where the processor 40b determines the location of the peripheral device 10, the processor 40b may trigger the circuit breaker 52 to disable one or more operations of the peripheral device 10 based on the location. For example, if the processor 40b determines that the peripheral device 10b is not in any room of a site using the local tracking technique, the processor 40b may trigger the circuit breaker 52 to eliminate access to data from the memory component 22b of the peripheral device. In another example, if the processor 40b determines that the peripheral device 10 is not on-premises at a site using the remote tracking technique, the processor 40b may trigger the circuit breaker 52 to delete all data from the memory component 22b of the peripheral device.

In some embodiments, a remote managing service, such as the remote managing service 210 (shown in FIG. 8 and further described herein), may receive the location of the peripheral device 10 and trigger the circuit breaker 52 based on the location of the peripheral device 10. For example, after the processor 40b determines the location of the peripheral device 10, the processor 40b may transmit the location to the remote managing service 210 via the network interface 44. The remote managing service 210 may then trigger the circuit breaker 52 if the peripheral device 10 is not on-premises at a site or not in a location within the site.

Furthermore, the remote managing service 210 may enable administrator(s) to remotely manage and monitor the location of the peripheral devices 10. As such, the administrator(s) may determine whether the circuit breaker 52 should be triggered after monitoring the location of the peripheral device 10. For example, after the processor 40b determines and transmits the location of the peripheral device 10 to the remote managing service 210, an administrator may view the location of the peripheral device 10 and decide whether to restrict access to data from the memory component 22b of the peripheral device or delete all data from the memory component 22b of the peripheral device via the remote managing service 210.

I. Remote Service/Configuration of Peripheral Device(s)

The peripheral device 10 may locally protect the corresponding host device 12 in a stand-alone mode. Additionally, referring to FIG. 8, the peripheral device 10 may be configured to securely communicate with a remote managing service 210 that can manage aspects of the peripheral device 10.

A remote service/configuration system 200 is provided wherein a plurality of host devices 12a, 12b are paired with respective peripheral devices 10a, 10b. It should be understood that any number of devices 10, 12 can be utilized in the system 200. Further shown is one peripheral device 10n that is standing alone, i.e., not coupled to a corresponding host device 12.

The peripheral devices 10a-10n communicate with the remote managing service 210 that is configured to manage the various peripheral devices 10a-10n, whether paired with the host device 12 or standing alone. The numerous peripheral devices 10a-10n establish a fleet of peripheral devices 10a-10n managed by the remote managing service 210.

The peripheral devices 10a-10n communicate with the remote managing service 210 over a network 212, which can be any network, such as those described herein, or equivalents thereof. In one example, the network 212 is a cloud computing network. Each peripheral device 10a-10n can communicate with the remote managing service 210 using the network interface 44, or equivalents thereof. Any of the aforementioned services described above can also be employed for the remote managing service techniques described herein. The remote managing service 210 may be any server (as shown in FIG. 8), computer, or computing device configured to execute the functions described herein. In one example, the remote managing service 210 is modeled as a security as a service (SaaS). The remote managing service 210 may be implemented using software stored on non-transitory computer readable media.

The peripheral devices 10a-10n may subscribe to the remote managing service 210 either at the time of manufacturing/set-up or as desired by the user of the peripheral device 10a-10n. The peripheral device 10a-10n may comprise a subscription protocol or program for prompting a GUI on a display device to enable a user to subscribe to the remote managing service 210. Because service setup is generally decoupled from the host device 12, this feature may be available by inserting the peripheral device 10a-10n into any computing device configured to receive the direct interface 16b. Communication to the remote managing service 210 may be enabled after the peripheral device 10a-10n successfully subscribes to the remote managing service 210.

The remote managing service 210 enables administrator(s) to remotely manage and monitor both the peripheral devices 10a-10n and the corresponding host devices 12a, 12b. Such managing and monitoring can be performed at a local level (e.g., at a hospital facility), a regional level (e.g., hospital facilities within the state), and even at a national or global level.

The remote managing service 210 may employ an updating service 214, which is configured to transmit firmware or security updates to the peripheral devices 10a-10n. The peripheral devices 10a-10n receive the updates and update any firmware or software to implement the same.

The updates can include updates to the security protocol and/or the firewall and policies/rules related to the same. The updates can be distributed in order to keep the peripheral device 10a-10n up to date with regard to combatting recently discovered advancements in hacking, malware, viruses, unsafe data, malicious requests, and other potential security breaches. The updates may include updates to the UDID of the peripheral device 10a-10n and/or the host device 12a, 12b.

The updates can be distributed according to an update schedule and/or as new updates are created. For example, the update schedule can enable the security update service to distribute updates daily, weekly, monthly, yearly, or a combination thereof.

As shown in FIG. 8, the remote managing service 210 may implement a monitoring service 216 that is configured to monitor security events, security behavior or any other pertinent information related to the peripheral devices 10a-10n and the corresponding host devices 12a, 12b.

The monitoring service 216 can be performed without impacting or interfering with validated purposes of the host device 12a, 12b or its legitimate connection to the regulated or open network for data sharing and without procuring or accessing data other than what is truly required to protect the integrity of the host device 12a, 12b, such as packet filtering data.

The monitoring service 216 may monitor packet-level intrusions related to the peripheral devices 10a-10n. Peripheral devices 10a-10n failing for intrusion, will indicate an intrusion to the upstream server employing the remote managing service 210.

Other examples of monitoring services 216 include, but are not limited to: device location, device usage, authentication attempts (successful or failed), firewall activity, network interface 44 performance/activity, detected tampering, error logs, IP restrictions, policy/rule enforcement, audit logs, password management, report generation, permission set-up, message management, and the like.

The remote managing service 210 and hardware/software/functionality thereof may include features other than those described herein and that the remote managing service 210 capabilities are not limited solely to those described herein.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. A system comprising:
a host device configured to communicate over a network and comprising:
a first processor;
a first memory component coupled to the first processor and configured to store a first unique device identifier (UDID) associated with the host device; and
a first interface coupled to the first processor;
a peripheral device being separate and distinct from the host device and comprising:
a second processor;
a second memory component coupled to the second processor and configured to store a second UDID associated with the peripheral device; and
a second interface coupled to the second processor and with the second interface configured to physically and removably attach to the first interface to trigger evaluation of the UDIDs to establish authentication between the host device and the peripheral device such that the peripheral device is operable solely with the host device, and wherein the peripheral device is configured to implement cyber-security features for the host device relative to the network when authenticated.

2. The system of claim 1, wherein the peripheral device is configured to open network access for the host device upon successful authentication between the host device and the peripheral device.

3. The system of claim 1, wherein the peripheral device is configured to implement network encryption for data transmitted to the host device over the network and for data transmitted from the host device over the network.

4. The system of claim 1, wherein the first and second interfaces are configured to implement hardware encryption.

5. The system of claim 1, wherein the peripheral device is configured to implement an external firewall between the network and the host device.

6. The system of claim 1, wherein the first and second UDIDs are associated with the first and second interfaces.

7. The system of claim 1, wherein the peripheral device is configured to mask an IP address of the host device.

8. The system of claim 1, wherein the peripheral device comprises an intrusion mitigation device configured to temporarily or permanently disable functionality of the peripheral device upon detection of an intrusion into the peripheral device from the network.

9. The system of claim 1, wherein the peripheral device and the host device comprise a locking mechanism configured to lock the peripheral device and the host device to one another based on establishing authentication between the host device and the peripheral device.

10. The system of claim 1, wherein the peripheral device comprises a location tracker configured to connect to a network to enable determining of a location of the peripheral device.

11. The system of claim 10, wherein the location tracker of the peripheral device is a first location tracker and the system comprises a second location tracker such that the first location tracker is configured to communicate with the second location tracker when the first location tracker and the second location tracker are within a proximity of one another to enable determining a location of the peripheral device.

12. A peripheral device for implementing cyber-security features for a host device, the host device configured to communicate over a network and comprising a first processor, a first memory component coupled to the first processor and configured to store a first unique device identifier (UDID) associated with the host device, and a first interface coupled to the first processor, the peripheral device being separate and distinct from the host device, the peripheral device comprising:
a second processor;
a second memory component coupled to the second processor and configured to store a second UDID associated with the peripheral device; and
a second interface coupled to the second processor and with the second interface configured to physically and removably attach to the first interface to trigger evaluation of the UDIDs to establish authentication between the host device and the peripheral device such that the peripheral device is operable solely with the host device, and wherein the second processor of the peripheral device is configured to implement cyber-security features for the host device relative to the network when authenticated.

13. The peripheral device of claim 12, wherein the second processor is configured to open network access for the host device upon successful authentication with the host device.

14. The peripheral device of claim 12, wherein the second processor is configured to implement network encryption for data transmitted to the host device over the network and for data transmitted from the host device over the network.

15. The peripheral device of claim 12, wherein the second interface is configured to implement hardware encryption with the first interface.

16. The peripheral device of claim 12, wherein the second processor is configured to implement an external firewall between the network and the host device.

17. The peripheral device of claim 12, wherein the second UDID is associated with the second interface.

18. The peripheral device of claim 12, wherein the second processor is configured to mask an IP address of the host device.

19. The peripheral device of claim 12, further comprising an intrusion mitigation device configured to temporarily or permanently disable functionality of the peripheral device upon detection of an intrusion into the peripheral device from the network.

20. A remote management service implemented on a remote server and configured to remotely monitor and manage the peripheral device of claim 12.

21. A method of providing cyber-security to the host device using the peripheral device as set forth in claim 12.

22. A computer-implemented method for remotely monitoring a plurality of peripheral devices using a remote service implemented on a remote server, each peripheral device being configured to communicate with the remote server over a network, each peripheral device being uniquely paired with a corresponding host device such that each peripheral device is operable solely with the corresponding host device, each peripheral device comprising an interface configured to physically and removably attach to an interface of the corresponding host device for triggering an authentication process with the corresponding host device, and with each peripheral device being configured to implement cyber-security features for the corresponding host device when authenticated, the computer-implemented method comprising:
communicating with the peripheral devices over the network using the remote server;
remotely monitoring, with the remote server, cyber-security features or behavior of the peripheral devices;
detecting, with the remote server, an occurrence relating to cyber-security features or behavior of one or more peripheral devices; and
executing, with the remote server, a computer-implemented action to address the occurrence.

23. The computer-implemented method of claim 22, wherein remotely monitoring comprises the remote server monitoring any one or more of:
location of each peripheral device;
usage of each peripheral device with the corresponding host device;
network or firewall activity of each peripheral device; and
software/firmware versions of the peripheral devices.

24. The computer-implemented method of claim 22, wherein detecting the occurrence comprises the remote server detecting any one or more of:
packet-level data intrusion of one or more peripheral devices;
physical tampering of one or more peripheral devices; and
outdated software/firmware of one or more peripheral devices.

25. The computer-implemented method of claim 22, wherein executing the computer-implemented action comprises the remote server executing any one or more of the following actions:
remotely disabling or destroying one or more peripheral devices; and
remotely updating outdated software/firmware of one or more peripheral devices.
